(19) United States
(12) Patent Application Publication
(10) Pub. No.: US 2020/0003244 A1
(43) Pub. Date: Jan. 2, 2020

(54) ANCHORING SYSTEM

(71) Applicant: EPODPAK INTERNATIONAL HOLDINGS LIMITED, Hong kong (HK)

(72) Inventor: D'Art Daniel David BRAEDER, New South Wales (AU)

(21) Appl. No.: 16/490,868

(22) PCT Filed: Feb. 6, 2018
(86) PCT No.: PCT/GB2018/000020

§ 371 Date: Sep. 3, 2019

(30) Foreign Application Priority Data
Mar. 4, 2017 (GB) 1703510.6

(51) Int. Cl. F16B 13/14

(52) U.S. Cl. CPC F16B 13/144; F16B 35/04; F16B 13/146

(57) ABSTRACT

The invention relates to an anchoring system for anchoring a securing means such as a bolt in a bore of a substrate, comprising a plurality of rupturable containers each for holding a respective component of a multi-component adhesive, the containers being adjacent and each having a plurality of longitudinally spaced frangible means having a configuration including a transverse element and an elongate element, so that on application of at least a rotational force, the containers twist and the frangible means rupture and form opposed container segments whereby to enhance mixing of the components of the adhesive.

The invention relates to a system for anchoring a securing device such as a screw, bolt, expansion bolt or the like in a bore in a substrate.

Such systems often comprise a container for each of respective mixable components of an adhesive, for example an epoxy resin adhesive. The containers are usually separate, and one container may hold an epoxy resin and the other a curing agent or hardener for the resin. The respective containers are usually required to be opened separately for subsequent mixing and then curing or setting of the adhesive. Among problems associated with such a system is that of ensuring as prompt a mixing of the components as possible on opening of the containers, which being separate often causes a delay in mixing with loss of efficacy in forming the adhesive, and of inserting the adhesive in the bore before hardening.

It is an object of the invention to seek to overcome this and other disadvantages of the prior art.

According to a first aspect of the invention there is provided an anchoring system for anchoring a securing means such as a bolt in a bore of a substrate, comprising a plurality of rupturable containers each for holding a respective component of a multi-component adhesive, the containers being adjacent, frangible means of the containers having a configuration including a transverse element, so that on application of at least a rotational force, the containers twist and the frangible means rupture and form opposed container segments whereby to enhance mixing of the components of the adhesive

According to a second aspect of the invention there is provided an anchoring system as hereinbefore defined, with adhesive components in the respective containers.

Using the invention the segments lie opposite one another both horizontally and vertically so that on breaking of the frangible means even distribution of the adhesive components is provided before any dynamic mixing owing to the rotation of a bolt in use.

An anchoring system for anchoring a securing means such as a bolt in a bore of a substrate is hereinafter described, by way of example, in the accompanying drawings.

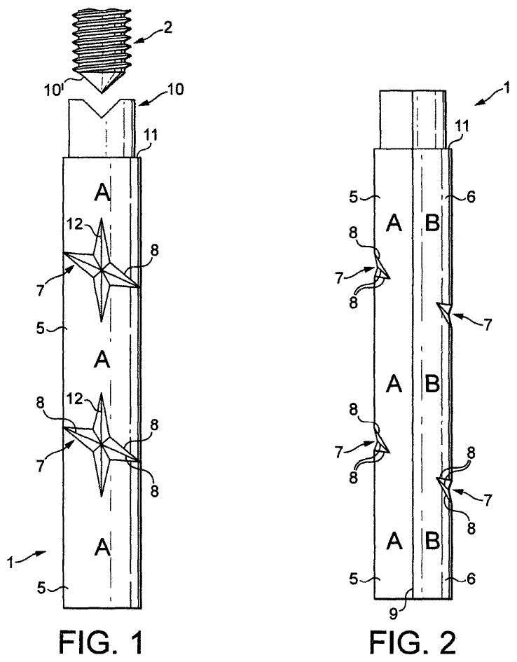

FIG. 1 shows a schematic elevational view of the system from one direction;

FIG. 2 shows a schematic elevational view of the system of FIG. 1, turned through right angles with respect to that FIG. ;

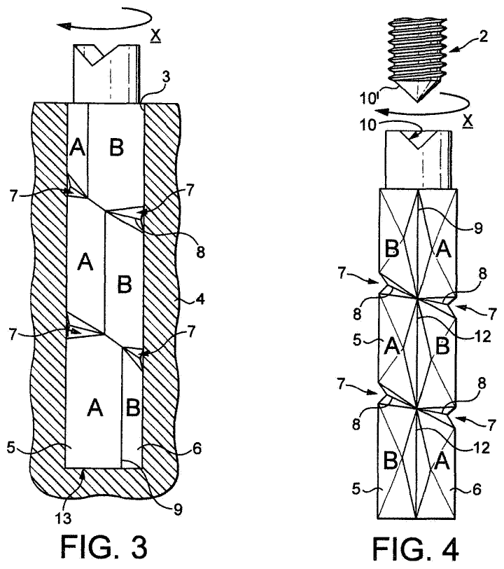

FIG. 3 shows a schematic view similar o that of FIG. 2 but inserted in a bore of a substrate and on initial application of a rotational force;

FIG. 4 shows a schematic view similar to that of FIG. 3, on application of further rotational and downward force; and

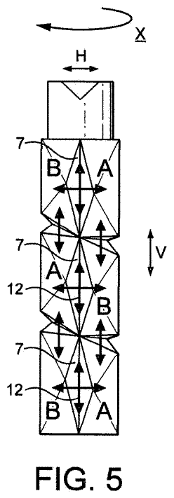

FIG. 5 shows schematically mixing of adhesive components after rupture of frangible means of the system.

It will be understood that the bore may be a substantially vertical blind bore in a horizontal substrate such as a floor or ceiling, or a substantially horizontal blind bore in an upright such as a wall or partition. The following description should accordingly be read in the foregoing context.

Referring to the drawings, there is shown an anchoring system 1 for anchoring a securing means such as a bolt 2 in a bore 3 of a substrate 4, comprising a plurality of rupturable containers 5, 6 each for holding a respective component of a multi-component adhesive (not shown), the containers 5, 6 being adjacent, frangible means 7 of the containers having a configuration including a transverse element 8, so that on application of at least a rotational force, the containers 5, 6 twist and the frangible means 7 rupture and form opposed container segments or sections A, B whereby to enhance mixing of the components of the adhesive.

The containers 5, 6 are in the embodiment of semi-cylindrical configuration and made of a suitable material such as plastic. The multi-component adhesive may be in the embodiment an epoxy resin adhesive, one component being a hardener or curer for the resin. One container 5, say, in use holds resin, the other 6 the hardener or curer. When filled, the interior of each container is covered by a membrane or foil, the foils being laid face-to face in contact along a line 9. A proximal end 10 of the system 1 has a configuration complementary to end 10′ of the bolt 2, in the embodiment the ends 10, 10′ being of V-shape. There is also a seating 11 for receiving a holder,cap or cover (not shown) for keeping the membranes or foils together in face-to-face contact along the line 9 so that entry into the bore 3 in use is facilitated.

The frangible means 7 of the two containers 5, 6 are, as shown in the embodiment, two in number, spaced apart longitudinally along the length of the containers 5, 6 to provide in the embodiment in use, three segments or sections A, B, as will be described. Each frangible means 7 comprises a substantially vertical, or substantially longitudinally, extending element 12, and two transverse diagonal or inclined elements 8 forming a substantially triangular configuration. Each frangible means 7 is thus of substantially star-shape and is diagonally disposed, as shown in FIG. 1.

The frangible means 7 in each case is an indented impression in the outer surface of the respective containers 5,6 though they could be on the interior surface instead. In either case, the frangible means forms a zone of weakness which can be broken on application of force.

In operation, an anchoring system 1 as shown is offered up to the bore 3 and inserted therein with the proximal end 10 external to the bore 3. The container 5 in which say the epoxy is housed, is opposite the container 6 in which say the hardener is housed, as shown in FIGS. 1-3. The bolt 2 is offered up to the proximal V-shape end 10 of the system 1 and inserted therein, the bolt 2 itself being gripped by a tool such as an impact or percussion wrench (not shown). On application of rotational and downward forces to insert and anchor the bolt 2 in the bore 3, the containers 5,6 twist on themselves and begin to move relative to one another both vertically ‘V’ and horizontally ‘H’, FIG. 5, and as shown in FIG. 3, the rotational force being indicated at X. When the system 1 is hard against the closed end 13 of the bore 3 the containers 5,6 become completely twisted on themselves so that the segments or sections A of container 5 are opposite the sections or segments B of the container 6, both substantially vertically and substantially horizontally as shown in FIG. 4. This is brought about on twisting by the two containers 5, 6 being separated equally by the diagonal frangible means 7. As the rotational and downward forces continue, the frangible means rupture diagonally and vertically and form in the embodiment the three equal and opposite smaller container segments or sections A, B. The adhesive components are thus evenly distributed in the bore 3 by the separation of the containers into the opposing smaller segments or sections A and B.

It will be understood that as the bolt 2 rotates, the evenly distributed adhesive components are mixed dynamically as the components travel up the thread of the bolt. The process of dynamic mixing by the bolt is thus enhanced by the position and use of the frangible means, in the embodiment two, spaced longitudinally along the length of the anchoring system as described with reference to the embodiment shown in the drawings. It will be understood that the bolt 2 thus essentially comprises a mixing device or stick while the impact wrench holds the bolt's proximal end and drives it down into the bore.

The anchoring system 1 shown and described with reference to the drawings thus can provide a firm anchoring of the bolt 2 as the adhesive components are evenly distributed and mixed along the length of the bore 3 prior to curing.

1. An anchoring system for anchoring a securing means such as a bolt in a bore of a substrate, comprising a plurality of rupturable containers each for holding a respective component of a multi-component adhesive, the containers being adjacent, wherein frangible means of the containers having a configuration including a transverse element, so that on application of at least a rotational force, the containers twist and the frangible means rupture and form opposed container segments whereby to enhance mixing of the components of the adhesive.

2. A system according to claim 1, wherein the containers being elongate and by the frangible means comprising an element lying substantially longitudinally of the length of the containers.

3. A system according to claim 2, wherein the transverse element being inclined to the length of the longitudinal element.

4. A system according to claim 3, wherein the transverse element comprising a diagonally inclined element.

5. A system according to claim 4, wherein there being two diagonally inclined elements defining a substantially triangular configuration element.

6. A system according to claim 2 wherein the frangible means being of substantially star-shaped configuration.

7. A system according to claim 2, wherein the frangible means comprising impressions in the material of the containers containers.

8. A system according to claim 1 wherein comprising three longitudinally arranged segments.

9. A system according to claim 1 wherein the containers being made of plastic.

10. A system according to claim 9, wherein the containers each being of substantially semi-cylindrical configuration with a membrane closing the interior, and by the membranes lying in face-to-face contact along a line.

11. A system according to claim 10, wherein there being a cover means holding the membranes in face-to-face contact along the line.

12. A system according to claim 1 wherein a proximal end of the containers defining means for complementary engagement with an end of a bolt means in use.

13. A system according to claim 12, wherein the means of the proximal end being of substantially V-shape.

14. A system according to claim 7 wherein the impressions being in the exterior surface of the respective container.

15. A system according to claim 1 wherein the containers holding respective adhesive components.
